(19) United States
(12) Patent Application Publication
(10) Pub. No.: US 2002/0053867 A1
(43) Pub. Date: May 9, 2002

(54) Cathod-ray tube

(75) Inventors: Nijs Van Der Vaart, Eindhoven (NL); Eduard Matheus Johannes Niessen, Eindhoven (NL); Martin Gerard Hendrik Hiddink, Eindhoven (NL); Gerardus Gegorius Petrus Van Gorkom, Eindhoven (NL); Bernardus Hendrikus Wihelmus Hendriks, Eindhoven (NL); Petrus Hubertus Franciscus Trompenaars, Eindhoven (NL); Willibrordus Adrianus Johannes Antonius Van Der Poel, Eindhoven (NL)

Correspondence Address: U.S. Philips Corporation, 580 White Plains Road, Tarrytown, NY, 10591, US

(73) Assignee: Koninklijke Philips Electronics N.V.

(21) Appl. No.: 09/962,653

(22) Filed: Sep. 25, 2001

(30) Foreign Application Priority Data
Sep. 27, 2000 (EP) 00203345.4

(51) Int. Cl. H01J 29/46

(52) U.S. Cl. 313/446

(57) ABSTRACT

A cathode ray tube comprising an electron source and an electron beam guidance cavity having an input aperture and an output aperture, wherein at least a part of the wall of the electron beam guidance cavity near the output aperture comprises an isolating material having a secondary emission coefficient δ1 for cooperation with the cathode and for forming an electron source. Furthermore, the cathode ray tube comprises a first electrode which is connectable to a first voltage source for applying, in operation, an electric field with a first field strength E1 between the cathode and the output aperture. δ1 and E1 have values, which allow electron transport through the electron beam guidance cavity. According to the invention, the cathode structure comprises means for reducing the spread of the energy distribution of the electrons leaving the exit aperture between the input of the cavity and the accelerating grid.

The invention relates to a cathode-ray tube as defined in the precharacterizing part of claim 1.

Such a cathode-ray tube may be used in television displays, computer monitors and projection TVs.

A cathode ray tube of the kind mentioned in the opening paragraph is known from U.S. Pat. No. 5,270,611. U.S. Pat. No. 5,270,611 describes a cathode ray tube which is provided with a cathode, an electron beam guidance cavity and a first electrode connectable to a first power supply means for applying the electric field with a first field strength E1 between the cathode and an exit aperture. The electron beam guidance cavity comprises walls in which, for example, a part of the wall near the exit aperture comprises an insulating material having a secondary emission coefficient δ1. Furthermore, the secondary emission coefficient δ1 and the first field strength E1 have values which allow electron transport through the electron beam guidance cavity. The electron transport within the cavity is possible when a sufficiently strong electric field is applied in a longitudinal direction of the electron beam guidance cavity. The value of this field depends on the type of material and on the geometry and sizes of the walls of the cavity. In a steady state, the electron transport takes place via a secondary emission process so that, for each electron impinging on the cavity wall, one electron is emitted on average. The circumstances can be chosen to be such that as many electrons enter the entrance aperture of the electron beam guidance cavity as will leave the exit aperture. When the exit aperture is much smaller than the entrance aperture, an electron compressor is formed which concentrates a luminosity of the electron source by a factor of, for example, 100 to 1000. An electron source with a high current density can thus be made. An accelerating grid accelerates electrons leaving the cavity towards the main electron lens. A main electron lens images the exit aperture of the cavity on the display screen and, via a deflection unit, a raster image is formed on the display screen of the tube. The spot size of the electron beam determines the resolution of the tube. Especially for computer monitor tubes and also television picture tubes, resolution may be an important feature. In the known cathode ray tube, the spot size of the electron beam on the display screen depends, amongst others, on the diameter of the exit aperture and the energy distribution of the electrons leaving the cavity.

A drawback of the known cathode ray tube is that the spot size of the electron beam on the display screen is negatively influenced by the broad energy distribution of the electrons leaving the cavity.

It is, inter alia, an object of the invention to provide a cathode ray tube in which the spot size of the electron beam on the display screen is further reduced. This object is achieved by the cathode ray tube according to the invention, which is defined in claim 1. The invention is based on the recognition that, in the known cathode ray tube, the electrons entering the exit aperture may release secondary electrons from the walls of the cavity. The initial starting energy of the secondary electrons will increase along the hopping trajectory due to the electric force acting in a transversal direction and/or a normal direction. This increase does not only contribute to the average energy, but also widens the spread of the energy distribution. By reducing of the spread of the energy distribution in the transversal direction and/or the normal direction, the spot size on the screen can be further reduced.

A particular embodiment of the cathode ray tube according to the invention is defined in claim 2. A funnel-shaped exit aperture allows hop entrance of electrons with a small electric force in the transversal direction with respect to the exit aperture. The average energy in the transversal direction of the electrons leaving the cavity is hardly increased in this embodiment, and, according, the spread of the energy distribution is hardly widened with respect to the initial energy. A further advantage of the concave shape of the exit aperture is that the surface of the exit aperture can be provided more easily with secondary emitter materials such as, for example, MgO, Al₂O₃ and glass. For example, the secondary emitter materials can be provided by sputtering or evaporation on the surface.

A further embodiment of a cathode ray tube according to the invention is defined in claim 3. In this patent application, the apex angle of the funnel-shaped aperture is defined as the angle 2α enclosed by the wall of the exit aperture. The apex angle 2α can be calculated by

$$\frac{1}{tan α} = \frac{F ⇒}{F } = \sqrt{\frac{{E}_{1} - 2 {E}_{0}}{4 {E}_{0}}} \qquad ( 1 )$$

Wherein

2α represents the apex angle,

F [symbol] represents the force normal to the surface of the funnel,

F [symbol] represent the force parallel to the surface of the funnel,

E₁ represents the lowest energy of the electrons for which the secondary emission equals one

and 2E₀ represents the average starting energy E₀ of the secondary electrons.

Given this apex angle 2α, the direction of the equipotential lines in the funnel is substantially parallel with the exit plane of the funel when the transport condition is met and without accounting for the effect of space charge. Since the electric force in the transversal direction now becomes substantially zero, the spread of the energy distribution becomes approximately equal to the starting energy of the secondary electrons, hence typically 2E₀. Both E₀ and E₁ are characteristics of the insulating material on the surface. For example, dependent on surface treatment, the values for E₀ and E₁ are 2.2 eV and 20 eV, respectively for MgO. With formula (1) the apex angle 2α becomes 70°. A theoretical background of the transport process on the surface of the insulators is given in “Basics of Electron Transport over Insulators”, by S. T. de Swart et al, Philips Journal of Research, No 50, 1996, pages 307-335.

A further embodiment of a cathode ray tube according to the invention is defined in claim 5. Sharp comers in the wall of the exit aperture, e.g. in a pyramid shape, may introduce lobs relatively far away from the average energy distribution of the electrons leaving the cavity. It has been found that rounded comers in the funnel-shaped exit aperture reduce these lobs in the energy distribution of the electrons and concentrate the energy distribution around a single peak.

A further embodiment of a cathode ray tube according to the invention is defined in claim 6. In this embodiment, the surface of the exit aperture is increased in one dimension and hence the current density in the exit aperture is reduced proportionally. This reduces the space charge density in the exit aperture, causing a reduction of the spread of energy distribution. The increase of the cross-section parallel to the exit plane of the exit aperture in the chosen dimension has to be balanced with a corresponding resolution loss in that dimension. For example, rectangular and oval shapes are possible.

A further embodiment of a cathode ray tube according to the invention is defined in claim 7. Providing the wall of the concave exit aperture with two angles of inclination reduces the chance that electrons will directly move through the exit aperture without wall interaction. Instead of two angles of inclination, it is also possible to provide the exit aperture with a concave wall, when seen from the cathode.

A different embodiment of a cathode ray tube according to the invention is defined in claim 8. In this embodiment, the voltage difference over the thin membrane is small compared to the voltage difference over the wall of the known cavity, which thickness is typically several 100 micrometers. The acceleration in the normal direction is small. Therefore, the spread of the energy distribution of the electrons moving through the exit aperture remains small and thus the increase of the average energy in the normal direction is small.

A further embodiment of a cathode ray tube according to the invention is defined in claim 9. The rim of the insulating material can be formed by removing some material of the electrically conducting rim around the exit aperture. The withdrawal of the first electrode from the exit aperture reduces the chance that electrons will move through the exit aperture without collision with the first electrode. The width of the insulating rim is restricted to 1 or 2 micrometers in order to prevent unwanted effects caused by charge collected at the insulating rim.

A further embodiment of a cathode ray tube according to the invention is defined in claim 10. In this embodiment, it has been found that the spread of the energy distribution of the normal direction is reduced by interaction of substantially all electrons leaving the exit aperture with the inner walls of the electrically conducting channel. The third predetermined voltage is chosen to be such that a sufficient landing energy is supplied to the electrons at the wall of the conducting channel to initiate secondary emission processes with an electron yield which is larger than or equal to 1. The electrically conducting channel may have the form of a tube or a funnel.

A further embodiment of a cathode-ray tube according to the invention is defined in claim 13. In this embodiment, the second electrode allows modulation of the current leaving the electron beam guidance cavity with a relatively low positive voltage difference, for example, in a range from 1 to 10 volts, with respect to the cathode, when the distance between the second electrode and the cathode is small enough. Consequently, low-cost, low-voltage electronics can be applied in the driving circuits of the cathode ray tube. This second electrode associated with the electron beam guidance cavity is described in the non-prepublished patent application EP 00/05645.

These and other aspects of the invention are apparent from and will be elucidated with reference to the embodiments described hereinafter.

In the drawings:

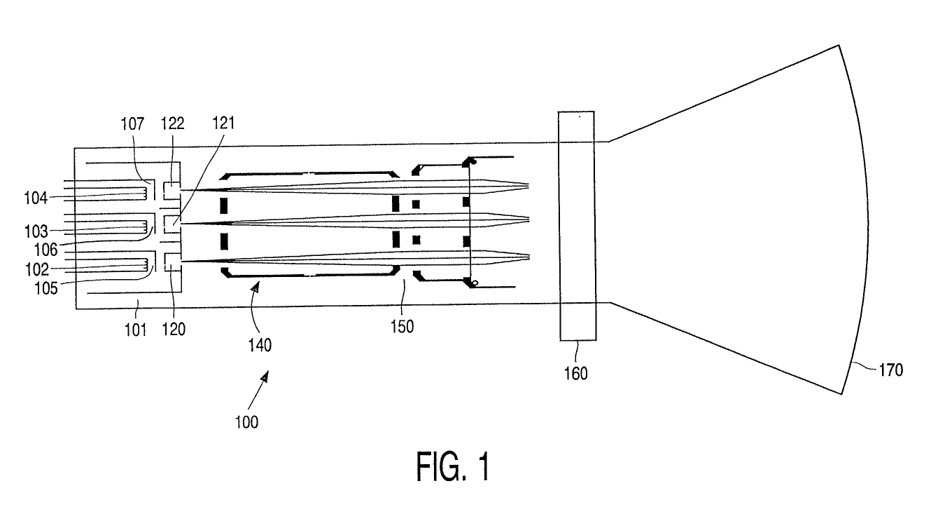

FIG. 1 is a schematic diagram of a cathode ray tube,

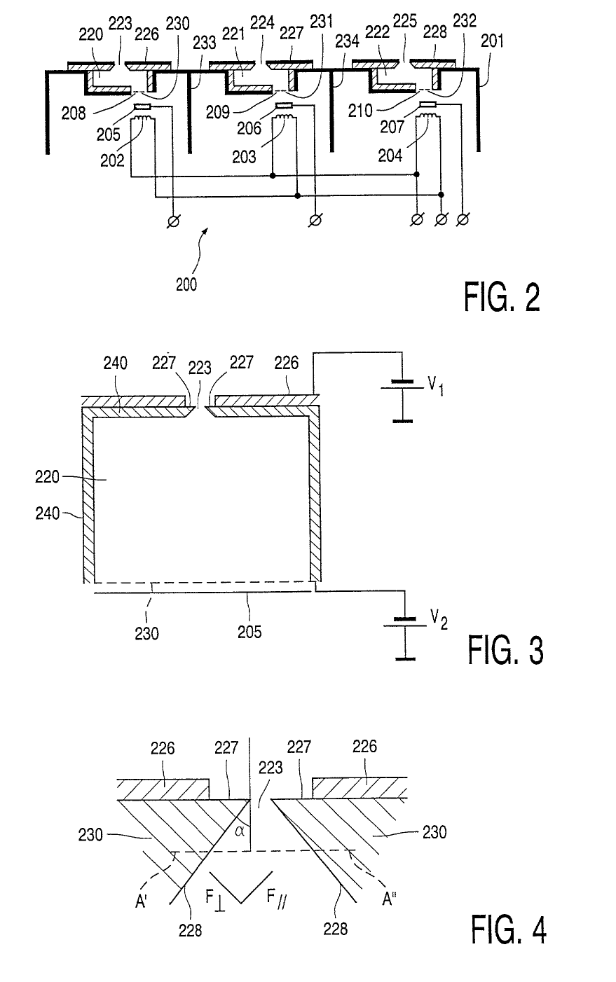

FIG. 2 shows a first embodiment of a cathode structure according to the invention for use in a cathode ray tube,

FIG. 3 shows a detail of the first embodiment of a cathode structure according to the invention,

FIG. 4 shows a funnel-shaped exit aperture of a cathode structure according to the invention,

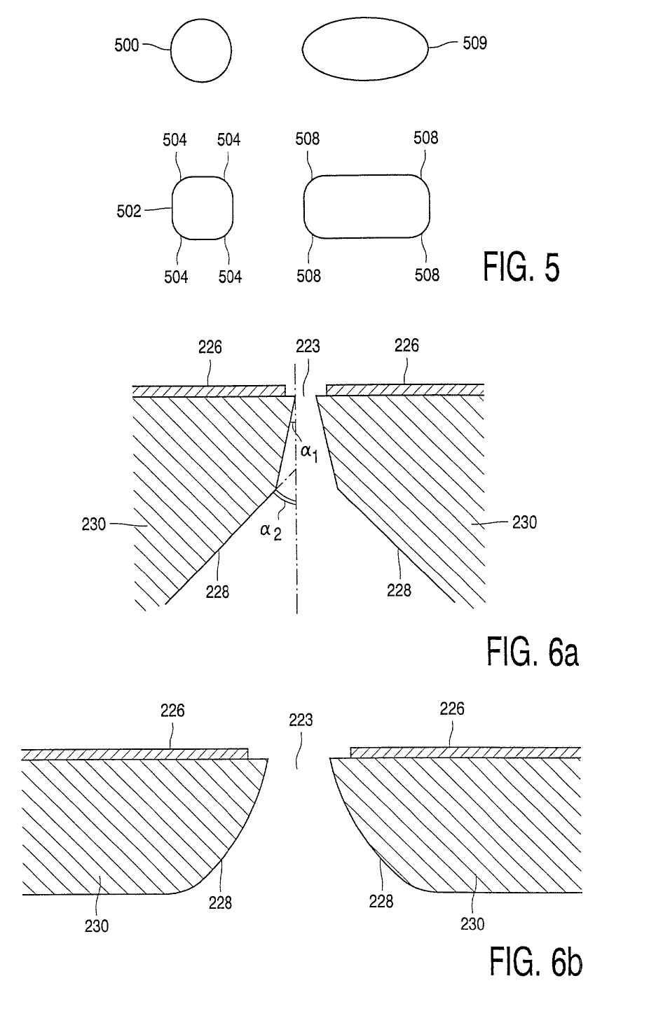

FIG. 5 shows different shapes of exit apertures,

FIG. 6 shows a funnel with two angles of inclination,

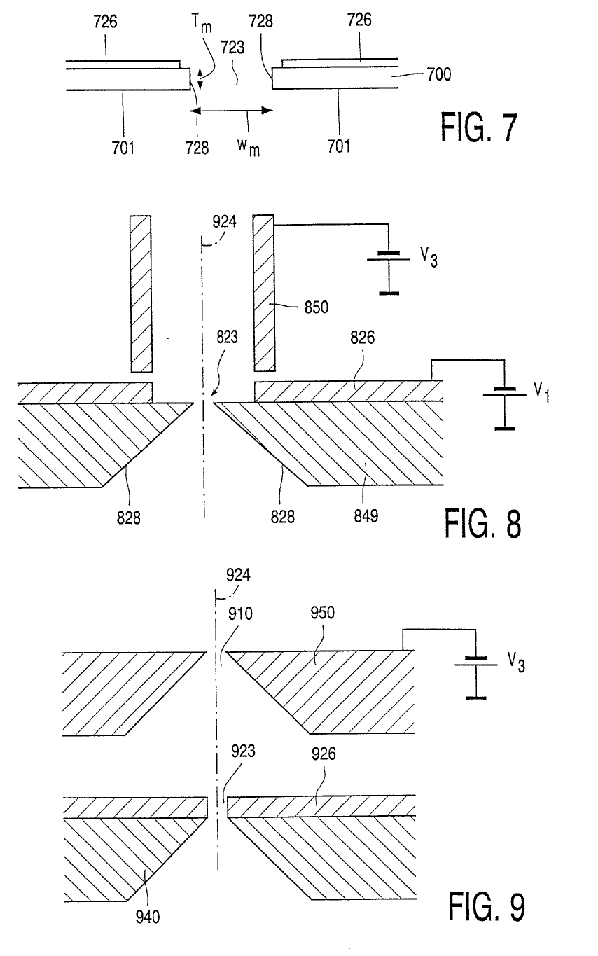

FIG. 7 shows an exit aperture provided in an insulating membrane,

FIG. 8 shows an exit aperture of an electron beam guidance cavity and a co-axially positioned electrically conductive tube, and

FIG. 9 shows an exit aperture of an electron beam guidance cavity and a co-axially positioned electrically conductive funnel.

FIG. 1 is a schematic diagram of a known cathode ray tube. This cathode ray tube is known per se from the cited U.S. Pat. No. 5,270,611. The cathode ray tube 100 comprises an electrode structure 101 having cathodes 105,106,107 for emission of electrons, and electron beam guidance cavities 120,121,122. Preferably, the cathode ray tube comprises heating filaments 102,103,104. Furthermore, the cathode ray tube comprises an accelerating grid 140, a conventional main lens 150, a conventional magnetic deflection unit 160 and a conventional color screen 170. All these parts are known from conventional color cathode ray tubes. The cathode ray tube according to the invention may be applied in television, projection television and computer monitors.

FIG. 2 shows a first embodiment of the cathode structure in accordance with the invention, which cathode structure may be applied in the cathode ray tube shown in FIG. 1. The cathode structure 200 comprises a frame 201, heating filaments 202, 203, 204 and cathodes 205,206,207 corresponding to each of the heating filaments. The cathodes are provided in triplicate so that the cathode ray tube may be used for the display of color images represented by red, green and blue signals. For display of black and white images with a monochrome cathode ray tube, a single cathode structure suffices. Furthermore, the cathode structure 200 comprises electron beam guidance cavities 220,221,222 each having an input aperture 208,209,210, an output aperture 223,224,225 and a first electrode 226,227,228. The input apertures 208,209,210 may have a square shape with dimensions of 2.5×2.5 mm. At least a part of the interior around the output apertures 223,224,225 of the electron beam guidance cavities 220,221,222 is covered with an insulating material having a secondary emission coefficient δ1 >1 for cooperation with the cathodes 205,206,207. This material comprises, for example, MgO. The MgO layer has a thickness of, for example, 0.5 micrometer. Other materials that can be used are, for example, glass or Kapton polyamide material. The first electrodes 226,227,228 are positioned around the output apertures 223,224,225 on the outer side of the electron beam guidance cavities 220,221,222. The first electrodes consist of a metal sheet. The metal sheet has a thickness of, for example, 1 micrometer and can be applied by metal evaporation of, for example a combination of aluminum and chromium. The output apertures 223,224,225 may have a circular shape with a diameter of, for example, 20 micrometers. Furthermore, each filament 202,203,204 for heating the cathodes 205,206,207 is coupled to an auxiliary power supply Va (not shown).In operation, each filament 202,203,204 heats up a corresponding cathode 205,206,207. The cathode comprises conventional oxide cathode material, for example, barium oxide.

In operation, the first electrode 226,227,228 is coupled to a first power supply V1 for applying an electric field with a field strength EVI between the cathode 205,206,207 and the output aperture 223,224,225. The voltage of the first power supply V1 is, for example, in the range between 100 and 1500 V, typically 700 V. The secondary emission coefficient δ of MgO and the given field strength EV1 have values which allow electron transport through the electron beam guidance cavity. This kind of electron transport is known per se from the cited U.S. Pat. No. 5,270,611.

Preferably, a second electrode 230,231,232 is placed between the input aperture 208,209,210 and the cathodes 205,206,207. The second electrode 230,231,232 is coupled to a second power supply means V2 (not shown) for applying, in operation, an electric field with a second field strength EV2 between the cathode 205,206,207 and the second electrode 230,231,232 for controlling the emission of electrons. Preferably, the second electrode 230,231,232 comprises a gauze with a 60% transmission of electrons. The gauze can be made of a metal, for example, molybdenum, and may be electrically coupled to the frame 201. In practice, all of the three gauzes 230,231,232 are electrically coupled to the frame 201. A voltage difference between the cathodes 205,206,207 and the gauzes 230,231,232 is determined by applying a fixed voltage to the frame and varying voltages to the gauzes. In operation, a pulling field due to the voltage difference applied between the gauzes 230,231,232 and the cathode 205,206,207 pulls the electrons away from the cathodes 205,206,207. The voltage differences between the cathodes 205,206,207 and corresponding gauzes 230,231,232 corresponds to R,G,B signals, respectively, which represent the image. For a further explanation of the operation of the cathode ray tube, reference is made to FIG. 1. After the electrons have left the output aperture 223,224,225 of the electron beam guidance cavity 220,221,222, the accelerating grid 140 accelerates the emitted electrons into the main lens 150. Via the main lens 150 and the deflection unit 160, the three electron beams corresponding to the red, green and blue signals are directed to the color screen 170 in order to build the image represented by the red, green and blue signals. Reference is now made to the structure shown in FIG. 2. When the distance between the gauze 230,231,232 and the cathode 205,206,207 is small enough, for example, in a range between 20 and 400 micrometers, a relatively low voltage difference between the cathode 205,206,207 and the gauze 230,231,232 can modulate the emission of the electrons towards the input aperture of the electron beam guidance cavity 220,221,222. For example, when the distance between the cathode 205,206,207 and the gauze 230,231,232 is 100 micrometers, a voltage swing of 5 volts between the cathode and the gauze can modulate an electron current of between 0 and 3 mA to the electron beam guidance cavity 220,221,222.

In order to reduce the spread of the energy distribution of the electrons leaving the cavity 220, the exit aperture 223 has a concave shape, and when seen from the cathode, the walls are inwardly directed. FIG. 3 is a cross-section of a frusto-conical by shaped exit aperture of the electron beam guidance cavity 220. The cathode structure comprises a conventional cathode 205, a modulation gauze 230 and the electron beam guidance cavity 220 with a wall 240 covered with MgO. The wall around the exit aperture 223 has a thickness of 100 micrometers. In this example for television applications, the diameter of the exit aperture at the outer side of the cavity is 20 micrometers. For monitor applications, which demands a smaller spot size on the display screen, the diameter of the exit aperture at the outer side of the cavity may be 10 micrometers. Around the exit aperture 223 of the cavity, the first electrode 226 is provided with an aluminum sheet 226 having a thickness of 1 micrometer. Instead of aluminum, other metals can be applied. This electron beam cavity can be used in the cathode ray tube described with reference to FIG. 1 and FIG. 2.

Preferably, a rim 227 of insulating material (MgO) is present at the outer side of the cavity 220 between the first electrode 226 and the exit aperture 223. This rim 227 reduces the chance that the electron can hit the first electrode 226 and can be trapped or cause secondary emission of electrons on the first electrode. The width of this rim 227 is limited in order to prevent building up of unwanted charge on the surface of this rim. This unwanted charge can pinch off the electron beam leaving the exit aperture 223. The width of the rim 227 is two orders of magnitude smaller than the thickness of the wall 240. In this example, the rim 227 has a width of about 1 micrometer.

FIG. 4 shows a detail of a cross-section of the exit aperture of the frusto-conical exit aperture. The apex angle 2α is defined as the angle enclosed by the inwardly directed walls 228 of the exit aperture 223. The apex angle 2α can be optimized according to the formula

$$\frac{1}{tan α} = \frac{F ⇒}{F } = \sqrt{\frac{{E}_{1} - 2 {E}_{0}}{4 {E}_{0}}} \qquad ( 1 )$$

wherein

2α represents the apex angle,

F [symbol] represents the force normal to the surface of the funnel,

F [symbol] represents the force parallel to the surface of the funnel,

E₁ represents the lowest energy of the electrons for which the secondary emission equals one and 2E₀ represents the average starting energy E₀ of the secondary electrons.

Given this apex angle 2α, the direction of the electric field lines in the exit aperture is substantially parallel with the exit plane of the exit aperture 223, under the conditions that the transport condition is met and without accounting for the effect of space charge. In this case, the electric force in the transversal direction, i.e. parallel to the exit plane, becomes substantially equal to zero and the spread of the energy distribution of the electrons leaving the cavity becomes approximately equal to the starting energy of the secondary electrons, hence typically 2E₀. Both E₀ and E₁ are characteristics of the insulating material. For example, dependent on the surface treatment typical values of E₀ and E₁ are 2.2 eV and 20 eV, respectively, for MgO and in this example in formula (1) the apex angle 2α of the funnel becomes 106°.

In order to reduce the spread of the energy distribution of the electrons in the normal direction of the exit aperture, a cross-section of the exit aperture parallel to the exit plane may have an elongated shape, for example, a rectangular or ellipsoidal shape. This elongation has to be balanced with a proportional loss of resolution on the display screen in the direction of the elongation axis.

In order to prevent unwanted lobs in the energy distribution of the moving electrons, a cross-section, taken on the line A′, A″ in FIG. 4 of the exit aperture 223, parallel to the exit plane may be provided with corners having a radius in the range between ½ and 1/10 of the radius of the inscribed circle of the cross-section.

FIG. 5 shows some examples of alternative cross-sections of the exit aperture 223 namely a circle 500, a square 502 with rounded corners 504, a rectangle 506 with rounded corners 508 and an ellipsoid 509.

Alternatively, in order to increase the chance of interactions of moving electrons with the wall of the exit aperture 223, it may be given two angles of inclination

FIG. 6 shows a concave exit aperture 223 having a first apex angle 2α₁ and a second apex angle 2α₂ with respect to a central axis. Preferably, the distance along a portion of the wall 228 of the exit aperture corresponding to the first apex angle 2α₁ is an order of magnitude larger than the hopping length of the secondary electrons along this wall. The hopping length of the secondary electrons along the wall 228 depends on the inverse value of the voltage V1 on the first electrode. In this example, the hopping length is typically five micrometers. The distance along the wall 228 is then about 50 micrometers. The trajectories of the electrons in this example have a greater mutual resemblance and the spread of the energy distribution of the electrons is reduced accordingly.

Alternatively, the wall 228 of the exit aperture 223 can be provided with a gradually inclined slope as shown in FIG. 6B.

In a further embodiment, the means reducing the spread of the energy distribution comprises the exit aperture of the electron guidance cavity being made in a membrane of insulating material, for example, MgO. FIG. 7 shows an exit aperture 723 of an electron guidance cavity made in a membrane 700 of MgO. The membrane 700 has such a thickness that virtually no electrons interact with the wall 728 of the exit aperture 723 and that the membrane 700 is still practically to handle. In this example, the membrane is made of MgO. Preferably, the thickness of the membrane is 2 to 5 times smaller than the diameter of the exit aperture. For television applications, the exit aperture 223 may have a diameter Wₘ. of for example 20 micrometers. In this example, the membrane has a thickness of 5 micrometers. The aluminum sheet 726 around the exit aperture 723 acting as the first electrode has a thickness of about 1 micrometer. This electron beam cavity can also be used in the cathode ray tube described with reference to FIG. 1 and FIG. 2. In operation, the electrons are moving along the surface 701 through the exit aperture 723, which acts as the electron source in the cathode ray tube 100. The main electron lens 150 images the exit aperture 723 on the display screen 110. In this example, the energy distribution is reduced because the voltage difference over the membrane is substantially equal to zero and the acceleration in the normal direction of the exit aperture is virtually zero. The average energy of the electron thus hardly increases and remains equal to E₁.

In a further embodiment, the means for reducing the spread of the energy distribution comprises an electrically conductive channel co-axially positioned between the exit aperture of the electron guidance cavity and the accelerating grid of the cathode ray tube. This cathode structure can also be used in the cathode ray tube described with reference to FIG. 1 and FIG. 2. FIG. 8 shows an example of a cross-section of a wall 849 of a cavity with an exit aperture 823 and, with respect to a main axis 824 of the exit aperture 823, a co-axially positioned electrically conductive tube 850. The wall 828 of the cavity 823 comprises an insulating material, for example, MgO. The first electrode 826 is connected to a first power supply V1 for providing a voltage difference between the cathode and the first electrode 826 to allow electron transport through the exit aperture 823. The conductive tube 850 is connected to a third power supply V3. The third power supply V3 provides a voltage V3 such that the voltage difference V1−V3 provides sufficient landing energy to the electrons in the electrically conductive tube 850 for initiating secondary electron emission with an electron yield which is larger than one. In this example, the voltage V1 is 800V and the voltage V3 is 1000V. Consequently, the voltage difference between the first electrode 850 and the electrically conductive tube 850 is about 200V. Furthermore, a voltage difference between the conductive tube 850 and an accelerating grid 140 of the cathode ray tube 100 should be sufficient to pull all the secondary electrons generated by the conductive tube 850 towards the display screen 170. The contribution to the energy distribution of the velocity component in the normal direction can then be reduced without affecting the contribution to the energy distribution of the velocity component in the transversal direction. Because all electrons leaving the exit aperture 823 of the electron guidance cavity will interact with the wall of the electrically conductive channel 850, the start potential of all the electrons is the same. By adjusting the voltage V3, the landing energy of these electrons can be adapted so as to bring about mainly secondary electron emission processes in the conductive tube 850. It has been found that under this condition the chance of a back-scattering process is minimized and the average starting energy of the electrons is reduced to an order of magnitude of 2E₀. This energy must then be distributed as energy in the normal and transversal directions, resulting in an average energy increase in both directions by the same order of magnitude.

Alternatively, an electrically conductive funnel may be used instead of an electrically conductive tube. FIG. 9 shows an electron guidance cavity with an exit aperture 923 and an electrically conductive funnel 950 co-axially positioned with respect to a main axis 924 of the exit aperture 923.

1. A cathode ray tube comprising
an electron source having a cathode for emitting of electrons,
an electron beam guidance cavity for concentrating electrons emitted from the cathode, said cavity having an entrance aperture and an exit aperture, a portion of an inner side of said cavity around the exit aperture being provided with an insulating material,
a first electrode being connectable to a first power supply means for applying, in operation, an electric field with a first field strength E1 between the cathode and the exit aperture to allow electron transport through the electron beam guidance cavity, and
a main electron lens for focusing the concentrated electrons on a display screen, characterized in that the cathode ray tube comprises means for reducing a spread of the energy distribution of the electrons leaving the cavity, the means being positioned between the input of said cavity and the main electron lens.

2. A cathode ray tube as claimed in claim 1, characterized in that the means for reducing the spread of the energy distribution comprises a funnel-shaped exit aperture.

3. A cathode ray tube as claimed in claim 2, characterized in that the apex angle 2α of the funnel-shaped aperture depends on the starting energy E₀ of the secondary electrons released from the insulating material and the lowest energy E₁ of the electrons impinging on the insulating material for which energy secondary electrons are released.

4. A cathode ray tube as claimed in claim 3, characterized in that the insulating material comprises MgO, and the funnel-shaped aperture has an apex angel 2α of about 106°.

5. A cathode ray tube as claimed in claim 2, characterized in that a cross-section of the exit aperture at the outer side of the cavity has a rectangular shape with corners having a radius, which is in the range between ½ and 1/10 of the radius of an inscribed circle of the rectangle.

6. A cathode ray tube as claimed in claim 1, characterized in that a cross-section of the exit aperture parallel to the exit plane has an elongated shape.

7. A cathode ray tube as claimed in claim 2, characterized in that the wall of the concave exit aperture is provided with two angles of inclination with respect to a central axis of the funnel-shaped aperture.

8. A cathode ray tube as claimed in claim 1, characterized in that the means for reducing the spread of energy distribution comprises the exit aperture being formed in a sheet of insulating material, the sheet having such a thickness that there is approximately no interaction between electrons moving through the exit aperture and the wall of the exit aperture.

9. A cathode ray tube as claimed in claim 1, characterized in that the first electrode comprises an electrically conducting rim around the exit aperture on the outer side of the cavity, the cathode ray tube further comprises a rim of insulating material around the exit aperture on the outer side of the cavity between the exit aperture and the electrically conducting rim, the width of the insulating rim being at least two orders of magnitude smaller than the thickness of the wall of the cavity.

10. A cathode ray tube as claimed in claim 1, characterized in that the cathode ray tube comprises an electrically conducting channel which is co-axially positioned between the exit aperture of the cavity and the main electron lens, the electrically conducting channel being connectable to a third power supply for supplying a third predetermined voltage to the electrically conducting channel, the voltage difference between the electrically conducting channel and the first electrode being such that sufficient landing energy is supplied to the electrons in the electrically conducting channel so as to initiate secondary emission with an electron yield which is larger than or equal to 1.

11. A cathode ray tube as claimed in claim 10, characterized in that the electrically conducting channel comprises an electrically conducting tube.

12. A cathode ray tube as claimed in claim 10, characterized in that the electrically conducting channel comprises an electrically conducting funnel.

13. A cathode ray tube as claimed in claim 1, characterized in that the cathode ray tube comprises a second electrode placed between the cathode and the electron guidance cavity, said second electrode being connectable to a second power supply for applying, in operation, an electric field with a second field strength E2 between the cathode and the second electrode so as to control the emission of electrons.
